(19) United States
(12) Patent Application Publication
(10) Pub. No.: US 2026/0323783 A1
(43) Pub. Date: Oct. 15, 2026

(54) ULTRASONIC GENERATOR AND ELECTRIC HEATING TUBE INTEGRATED HEATING MODULE

(71) Applicant: GUANGDONG AINI INTELLIGENT HOUSEHOLD ELECTRICAL APPLIANCE MANUFACTURING CO.,LTD., Foshan (CN)

(72) Inventors: Fei YANG, Foshan (CN); Xiongguang Guo, Yangjiang (CN); Huihe Lv, Foshan (CN)

(21) Appl. No.: 18/865,340

(22) PCT Filed: Mar. 29, 2024
(86) PCT No.: PCT/CN2024/084738

§ 371 Date: Nov. 13, 2024

(30) Foreign Application Priority Data
Dec. 21, 2023 (CN) 2023117702068

(51) Int. Cl. H05B 3/78; B06B 1/02; H05B 3/06

(52) U.S. Cl. CPC H05B 3/78; B06B 1/02; H05B 3/06; H05B 2203/021

(57) ABSTRACT

The invention relates to the technical field of electric water heater accessories, and discloses an ultrasonic generator and electric heating tube integrated heating module, which comprises a connecting flange, an electric heating tube and a water-immersed ultrasonic generator component, wherein the electric heating tube and the water-immersed ultrasonic generator component are fixedly arranged on the connecting flange to form an integrated heating module. The water-immersed ultrasonic generator component can effectively prolong the service life of the electric heating tube and a water heater liner by installing the electric heating tube and the water-immersed ultrasonic generator component on the connecting flange and removing scale by ultrasonic waves.

### TECHNICAL FIELD

The invention relates to the technical field of electric water heater accessories, in particular to an ultrasonic generator and electric heating tube integrated heating module.

### BACKGROUND ART

In the field of traditional water heaters, the electric heating tube is mainly used as a single heating element. Under the heating state, calcium, magnesium, salt and other components in the water are decomposed due to heat. The substances soluble in water are converted into substances insoluble in water. Moreover, the water in the container is continuously evaporated and concentrated due to heating, and the content of dissolved salts in the water continuously increases. When exceeding their solubility, the substances form a solid. Therefore, after a long time of heating, the substances attach to the electric heating tube and the water heater liner to form scales, which causes serious damage to the heating efficiency and service life of the electric heating tube, affecting the quality, service life and safety of the water heater liner.

Instant electric water heater is an electric heater which can quickly heat water through the electric heater and can control the water temperature, flow rate, power, etc. to reach the temperature suitable for human body bathing. It usually starts heating in a few milliseconds to achieve instant heating. For the small instant electric water heater, the liner space is narrow (the pipe diameter is below 40 mm). So, the electric heater element of the small instant electric water heater usually adopts an independent structure that the single high-power electric heating tube is assembled on the threaded screw head to adapt to the narrow installation space of the liner (the pipe diameter is below 40 mm). The workpiece with the descaling function of cannot be installed in the liner, so that the scales generated on the surface of the electric heating tube and the inner wall of the water heater cannot be removed, reducing the service life.

### SUMMARY OF THE INVENTION

The invention aims to overcome the deficiencies of the prior art, and provides an ultrasonic generator and electric heating tube integrated heating module, which has a compact structure by installing an electric heating tube and a water-immersed ultrasonic generator component on a connecting flange, can meet the installation requirements for a liner with narrow pipe diameter, and can effectively extend the service life of the electric heating tube and the heater liner by removing scales by ultrasonic waves.

To solve the above technical problems, the invention adopts the following technical proposal:
An ultrasonic generator and electric heating tube integrated heating module comprises a connecting flange, an electric heating tube and a water-immersed ultrasonic generator component, wherein the electric heating tube and the water-immersed ultrasonic generator component are fixedly arranged on the connecting flange to form an integrated heating module.

As a further improvement of the above technical proposal:
The electric heating tube and the water-immersed ultrasonic generator component are connected to the connecting flange in a detachable manner.

The electric heating tube and the water-immersed ultrasonic generator component are located in an imaginary cylinder with a rotating shaft of the connecting flange as the central axis and the outer diameter of the connecting flange as the diameter.

The water-immersed ultrasonic generator component comprises an ultrasonic transducer oscillator and a stainless steel rod connected to the ultrasonic transducer oscillator for generating ultrasonic waves.

The stainless steel rod comprises a head, a butting part and a water immersion rod part which are integrally formed from top to bottom, wherein the head is fixedly connected with the ultrasonic transducer oscillator, and the water immersion rod part passes through the connecting flange in order that the water immersion rod part and the electric heating tube are located on the opposite inner sides of the connecting flange, and the ultrasonic transducer oscillator and the head are located on the opposite outer sides of the connecting flange.

A mounting through hole is arranged on the connecting flange, a counterbored hole position is formed on one side of the mounting through hole away from the electric heating tube, the water immersion rod part threads through the mounting through hole, the butting part is arranged in the counterbored hole position, a fixing piece is connected to the connecting flange in a detachable manner and is butted with the top surface of the butting part so that the butting part is limited in the counterbored hole position.

A seal ring is sleeved on the water immersion rod part, and the bottom surface of the butting part is butted with the seal ring, so that the seal ring is compressed between the butting part and the counterbored hole position.

The ultrasonic generator and electric heating tube integrated heating module also comprises a master controller, which is electrically connected with the water-immersed ultrasonic generator component and the electric heating tube.

Compared with the prior art, the invention has the following advantages:
The ultrasonic generator and electric heating tube integrated heating module comprises a connecting flange, achieves a novel heating module with an integral structure composed of the electric heating tube and the water-immersed ultrasonic generator component by installing the electric heating tube and the water-immersed ultrasonic generator component on the connecting flange, replaces the independent structure of the single electric heating tube in the prior art, has the advantages of compact structure and small volume, meets the installation requirements for small instant electric water heater liners, especially the narrow liners with pipe diameter below 40 mm, realizes the function of ultrasonic descaling in the narrow space of the liner, effectively extends the service life of the electric heating tube and the water heater liner, and ensures the quality, service life and safety of the electric heating product.

### BRIEF DESCRIPTION OF THE DRAWINGS

FIG. 1 is the structure diagram for the ultrasonic generator and electric heating tube integrated heating module of the invention.

FIG. 2 is the structure diagram for the water-immersed ultrasonic generator component.

FIG. 3 is the enlarged diagram for part of the water-immersed ultrasonic generator component.

FIG. 4 is the front view for the i ultrasonic generator and electric heating tube integrated heating module of the invention.

FIG. 5 is the semi-sectional structure diagram for the ultrasonic generator and electric heating tube integrated heating module of the invention.

FIG. 6 is the enlarged view for part of the semi-sectional structure of the ultrasonic generator and electric heating tube integrated heating module of the invention.

FIG. 7 is the exploded view of FIG. 6.

FIG. 8 is the structure diagram for the electric control module of the ultrasonic generator and electric heating tube integrated heating module of the invention.

FIG. 9 is the flow diagram for the operation logic of the water-immersed ultrasonic generator component.

FIG. 10 is the assembly diagram for the ultrasonic generator and electric heating tube integrated heating module of the invention and the liner.

### REFERENCE SIGNS

100. Liner; 1. Connecting flange; 101. Mounting through hole; 102. Counterbored hole position; 2. Electric heating tube; 3. Water-immersed ultrasonic generator component; 301. Ultrasonic transducer oscillator; 302. Stainless steel rod; 3021. Head; 3022. Butting part; 3023. Water immersion rod part; 4. Fixing piece; 5. Seal ring.

### DETAILED DESCRIPTION OF THE INVENTION

The invention is further described in detail in combination with the drawings and embodiments.

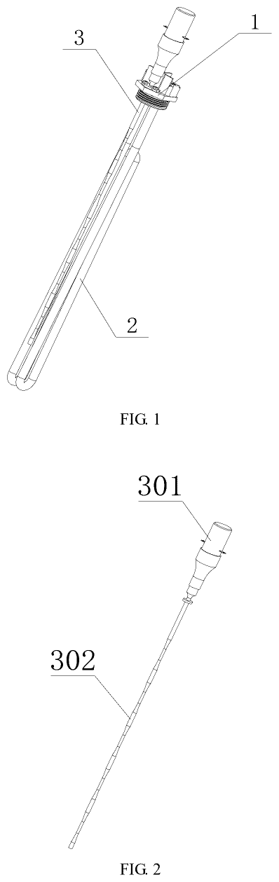

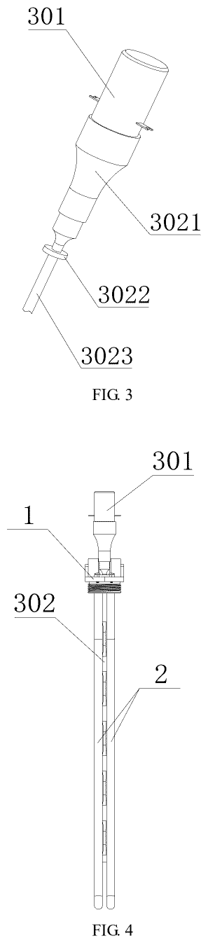

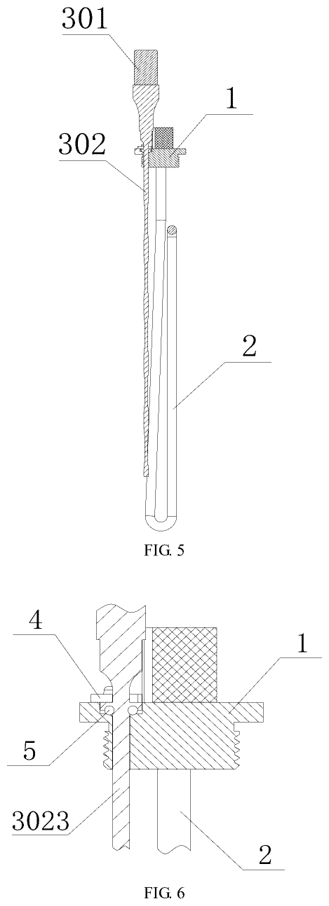

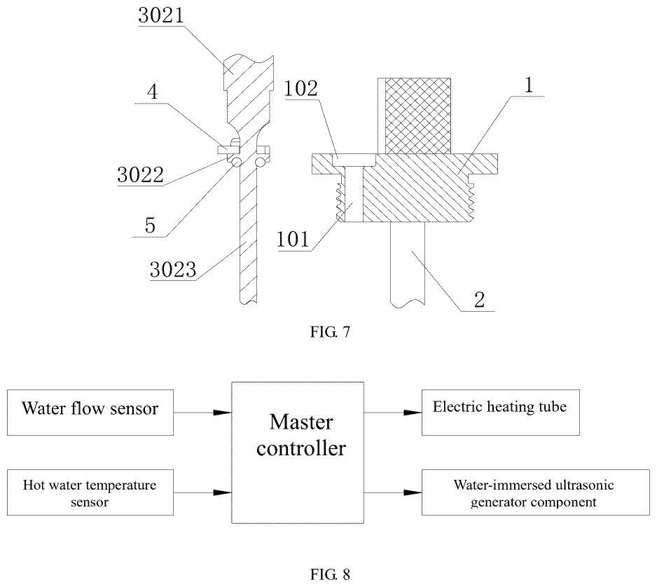

As shown in FIG. 1 to FIG. 7, an ultrasonic generator and electric heating tube integrated heating module in the embodiment comprises a connecting flange 1, an electric heating tube 2 and a water-immersed ultrasonic generator component 3, wherein the electric heating tube 2 and the water-immersed ultrasonic generator component 3 are fixedly arranged on the connecting flange 1 to form an integrated heating module. The ultrasonic generator and electric heating tube integrated heating module comprises the connecting flange 1, achieves a novel heating module with an integral structure composed of the electric heating tube 2 and the water-immersed ultrasonic generator component 3 by installing the electric heating tube 2 and the water-immersed ultrasonic generator component 3 on the connecting flange 1, replaces the independent structure of the single electric heating tube in the prior art, has the advantages of compact structure and small volume, meets the installation requirements for small instant electric water heater liners, especially the narrow liners with pipe diameter below 40 mm, realizes the function of ultrasonic descaling in the narrow space of the liner, effectively extends the service life of the electric heating tube 2 and the water heater liner, and ensures the quality, service life and safety of the electric heating product.

Preferably, the electric heating tube 2 and the water-immersed ultrasonic generator component 3 are connected to the connecting flange 1 in a detachable manner. In the embodiment, the electric heating tube 2 and the water-immersed ultrasonic generator component 3 are detachably connected to the connecting flange 1; when any component is damaged, the damaged part can be removed and replaced separately without the need to replace the integrated heating module integrally, greatly reducing the maintenance cost and being more convenient to use. In other embodiments, the electric heating tube 2 and the water-immersed ultrasonic generator component 3 can also be connected to the connecting flange 1 in a non-detachable manner, not limited to the embodiment.

Preferably, the electric heating tube 2 and the water-immersed ultrasonic generator component 3 are located in an imaginary cylinder with a rotating shaft of the connecting flange 1 as the central axis and the outer diameter of the connecting flange 1 as the diameter. In the embodiment, the connecting flange 1 is used to connect the water heater liner in order that the electric heating tube 2 and the water-immersed ultrasonic generator component 3 enter the water heater liner; the cylinder with the rotating shaft of the connecting flange 1 as the central axis and the outer diameter of the connecting flange 1 as the diameter is imaginary, the electric heating tube 2 and the water-immersed ultrasonic generator component 3 are located in the installation space of the imaginary cylinder, and then the integrated heating module of the invention can be installed on the water heater liner with the inner diameter at least equal to the outer diameter of the connecting flange 1, so that the installation requirement of the integrated heating module on the water heater liner is greatly reduced, the application range is wide, and the integrated heating module can be used for the water heater liners of various sizes and specifications, especially suitable for installation on the small instant electric water heater liners with pipe diameter below 40 mm and narrow liner space.

Preferably, the water-immersed ultrasonic generator component 3 comprises an ultrasonic transducer oscillator 301 and a stainless steel rod 302 connected to the ultrasonic transducer oscillator 301 for generating ultrasonic waves. In the embodiment, the ultrasonic transducer vibrator 301 is an energy conversion device, which is used to convert the input electrical power into mechanical power (i.e., ultrasonic wave) and then transfer; the stainless steel rod 302 is fixedly connected to the ultrasonic transducer vibrator 301 to ensure that the stainless steel rod 302 works with ultrasonic mechanical vibration, so that energy is emitted radially at 360 degrees, and then insoluble compound particles such as calcium carbonate and magnesium hydroxide on the surface of the electric heating tube 2 and the water heater liner cannot be easily deposited on the surface of the electric heating tube 2 to achieve the descaling effect and effectively extend the service life of the electric heating tube 2 and the water heater liner.

Specifically, ultrasonic descaling mainly uses ultrasonic power to produce ultrasonic energy on the corresponding ultrasonic oscillator so that the dirt is dispersed, loosened, broken, destroyed and falls off under the action of ultrasonic waves constantly through the cavitation in the liquid and is not easy to adhere to the tube wall, thus achieving the effect of ultrasonic descaling. The principle of ultrasonic descaling is mainly reflected in the following aspects: 1. Cavitation: The ultrasonic energy directly produces a large number of holes and bubbles in the treated fluid medium; when the sound pressure or intensity reaches a certain degree, the bubbles expand rapidly, and then suddenly close, producing a strong pressure peak within a certain range; the local pressure peak can reach thousands of bar pressure; scale-forming substances are broken, destroyed and suspended in water, and the natural scale layer is destroyed and easy to fall off. 2. Shear action: Ultrasonic radiation acts on scale layer, pipe wall and water body, which produce asynchronous vibration and high-speed relative motion due to the different response to ultrasonic frequency, and produce relative shear force on the interface between the scale layer and the electric heating tube 2 and the pipe wall of the water heater liner due to the speed difference to fatigue and loosen the scale layer, thereby achieving the purpose of ultrasonic descaling. 3. Inhibition: The physical and chemical properties of the fluid are changed under the action of ultrasonic waves, and the nucleation and growth of ions in water are inhibited on the tube wall, so that the number of dirt ions attached to the surface of the electric heating tube 2 and the pipe wall of the water heater liner is reduced. In summary, the ultrasonic generator and electric heating tube integrated heating module of the invention has the cleaning and anti-scaling effects in any place where the liquid can be immersed and the sound field exists.

Preferably, the stainless steel rod 302 comprises a head 3021, a butting part 3022 and a water immersion rod part 3023 which are integrally formed from top to bottom, wherein the head 3021 is fixedly connected with the ultrasonic transducer oscillator 301, and the water immersion rod part 3023 passes through the connecting flange 1 in order that the water immersion rod part 3023 and the electric heating tube 2 are located on the opposite inner sides of the connecting flange 1, and the ultrasonic transducer oscillator 301 and the head 3021 are located on the opposite outer sides of the connecting flange 1. In the embodiment, the first end and the second end of the electric heating tube 2 are U-shaped side by side and bent, the water-immersed rod part 3023 extends along the length direction of the electric heating tube 2 so that the water-immersed rod part 3023 overlaps with part of the electric heating tube 2, and the water-immersed rod part 3023 is located between the first end and the second end of the electric heating tube 2 to further improve the cleaning and anti-scaling effect of the electric heating tube 2.

Preferably, a mounting through hole 101 is arranged on the connecting flange 1, a counterbored hole position 102 is formed on one side of the mounting through hole 101 away from the electric heating tube 2, the water immersion rod part 3023 threads through the mounting through hole 101, the butting part 3022 is arranged in the counterbored hole position 102, a fixing piece 4 is connected to the connecting flange 1 in a detachable manner and is butted with the top surface of the butting part 3022 so that the butting part 3022 is limited in the counterbored hole position 102. In the embodiment, a sliding slot extending inward for the stainless steel rod 302 to be inserted is arranged on the fixing piece 4, and screw holes are respectively arranged on both sides of the fixing piece 4 corresponding to the sliding slot; when the water-immersed ultrasonic generator component 3 is installed on the connecting flange 1, the water immersion rod part 3023 threads through a mounting hole 101, then the butting part 3022 is arranged in the counterbored hole position 102, and finally the fixing piece 4 slides on the connecting flange 1, so that the stainless steel rod 302 is embedded in the sliding slot; two sets of screws pass through the screw holes and are connected to the connecting flange 1, so that the butting part 3022 is compressed in the counterbored hole position 102, which has the advantages of convenient installation and disassembly and good connection stability. Specifically, he installation of the electric heating tube 2 on the connecting flange 1 is a common prior art in the field of electric heating equipment, and its specific structure and installation procedure are not described here.

Preferably, a seal ring 5 is sleeved on the water immersion rod part 3023, and the bottom surface of the butting part 3022 is butted with the seal ring 5, so that the seal ring 5 is compressed between the butting part 3022 and the counterbored hole position 102. In the embodiment, the seal ring 5 is compressed between the butting part 3022 and the counterbored hole position 102 to form a water sealing structure, which can realize the water sealing at the connection between the stainless steel rod 302 and the connecting flange 1, and the sealing effect is good.

As shown in FIG. 8, preferably, the ultrasonic generator and electric heating tube integrated heating module of the invention also comprises a master controller, which is electrically connected with the water-immersed ultrasonic generator component 3 and the electric heating tube 2. In the embodiment, taking the integrated heating module of the invention assembled in the water heater liner as an example, the invention is small in volume and can meet the installation requirements for the small instant electric water heater, especially the narrow liner with pipe diameter below 40 mm, realizing the descaling function in the narrow space of the liner; during installation, the electric heating tube 2 and the water-immersed ultrasonic generator component 3 are extended into the water heater liner, the connecting flange 1 is connected with the water heater liner through threads, a connecting wire harness for the electric heating tube 2 and the water-immersed ultrasonic generator component 3 can be threaded through the connecting flange 1 and electrically connected with the external master controller, and a water flow sensor and a hot water temperature sensor are installed in the water heater liner and are electrically connected with the master controller; The master controller controls the operation of the water-immersed ultrasonic generator component 3 according to the operation logic shown in FIG. 9; Step 1: Detect the water flow, compare the real-time flow data sent by the water flow sensor with the preset water flow value, continuously detect the water flow if the real-time flow data is less than or equal to the preset value, and go to Step 2 if the real-time flow data is greater than the preset value; Step 2: Detect the water temperature and compare the real-time water temperature data sent by the hot water temperature sensor with the preset water temperature, go to Step 1 if the real-time water temperature data is less than or equal to the preset value, and go to Step 3 if the real-time water temperature data is greater than the preset value; Step 3: Calculate the ultrasonic operating power and start the water-immersed ultrasonic generator component 3, and operate according to the calculated ultrasonic operating power. Specifically, the master controller controls the operation of the electric heating tube 2, which is a common prior art in the field of electric water heaters, and its specific control logic is not detailed here.

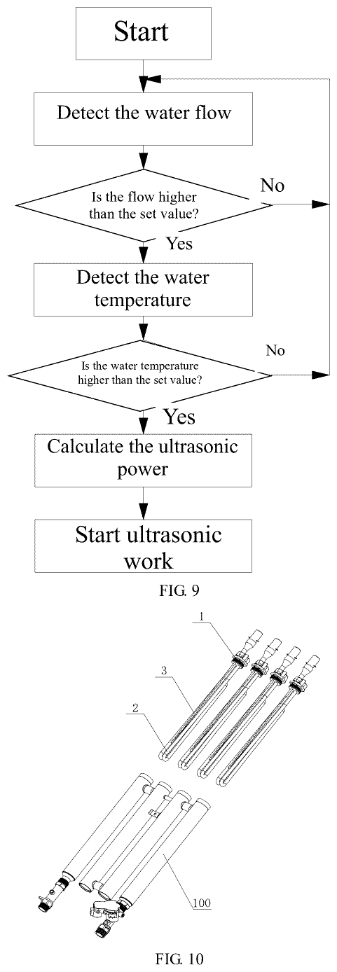

As shown in FIG. 10, in the actual application process, the liner 100 of the small instant electric water heater is narrow, and the ultrasonic generator and electric heating tube integrated heating module of the invention has compact structure and small volume, and can be directly installed in the liner 100, especially in the narrow liner with pipe diameter below 40 mm; after assembly, the liner 100, the electric heating tube 2 and the water immersion rod part 3023 are located in the same water body, and the ultrasonic transducer vibrator 301 makes the stainless steel rod 302 work with ultrasonic mechanical vibration, so that energy is emitted radially at 360 degrees along the water immersion rod part 3023, then insoluble compound particles such as calcium carbonate and magnesium hydroxide on the surface of the electric heating tube 2 and the water heater liner cannot be easily deposited on the surface of the electric heating tube 2, and the scales flow out of the liner 100 with the water flow to protect the electric heating tube 2 and the liner 100 and effectively extend the service life of the electric heating tube 2 and the liner 100.

The above is only the preferred embodiment of the invention. The scope of protection of the invention is not limited to the above embodiment. For the technicians in the technical field, the improvements and variations obtained without deviation from the technical conception of the invention should be considered as the scope of protection of the invention.

1. An ultrasonic generator and electric heating tube integrated heating module, characterized by comprising a connecting flange (1), an electric heating tube (2) and a water-immersed ultrasonic generator component (3), wherein the electric heating tube (2) and the water-immersed ultrasonic generator component (3) are fixedly arranged on the connecting flange (1) to form an integrated heating module;
The electric heating tube (2) and the water-immersed ultrasonic generator component (3) are located in an imaginary cylinder with a rotating shaft of the connecting flange (1) as the central axis and the outer diameter of the connecting flange (1) as the diameter.

2. The ultrasonic generator and electric heating tube integrated heating module according to claim 1, characterized in that the electric heating tube (2) and the water-immersed ultrasonic generator component (3) are connected to the connecting flange (1) in a detachable manner.

3. The ultrasonic generator and electric heating tube integrated heating module according to claim 2, characterized in that the water-immersed ultrasonic generator component (3) comprises an ultrasonic transducer oscillator (301) and a stainless steel rod (302) connected to the ultrasonic transducer oscillator (301) for generating ultrasonic waves.

4. The ultrasonic generator and electric heating tube integrated heating module according to claim 3, characterized in that the stainless steel rod (302) comprises a head (3021), a butting part (3022) and a water immersion rod part (3023) which are integrally formed from top to bottom, wherein the head (3021) is fixedly connected with the ultrasonic transducer oscillator (301), and the water immersion rod part (3023) passes through the connecting flange (1) in order that the water immersion rod part (3023) and the electric heating tube (2) are located on the opposite inner sides of the connecting flange (1), and the ultrasonic transducer oscillator (301) and the head (3021) are located on the opposite outer sides of the connecting flange (1).

5. The ultrasonic generator and electric heating tube integrated heating module according to claim 4, characterized in that a mounting through hole (101) is arranged on the connecting flange (1), a counterbored hole position (102) is formed on one side of the mounting through hole (101) away from the electric heating tube (2), the water immersion rod part (3023) threads through the mounting through hole (101), the butting part (3022) is arranged in the counterbored hole position (102), a fixing piece (4) is connected to the connecting flange (1) in a detachable manner and is butted with the top surface of the butting part (3022) so that the butting part (3022) is limited in the counterbored hole position (102).

6. The ultrasonic generator and electric heating tube integrated heating module according to claim 5, characterized in that a seal ring (5) is sleeved on the water immersion rod part (3023), and the bottom surface of the butting part (3022) is butted with the seal ring (5), so that the seal ring (5) is compressed between the butting part (3022) and the counterbored hole position (102).

7. The ultrasonic generator and electric heating tube integrated heating module according to claim 6, characterized by also comprising a master controller, which is electrically connected with the water-immersed ultrasonic generator component (3) and the electric heating tube (2).
